(19) United States
(12) Patent Application Publication
(10) Pub. No.: US 2025/0264672 A1
(43) Pub. Date: Aug. 21, 2025

(54) HIGH DENSITY MODULE WITH INTEGRATED EXPANDED BEAM OPTICAL CONNECTOR

(71) Applicant: viaPhoton, Inc., Aurora, IL (US)

(72) Inventors: Walter Mark HENDRIX, Dallas, TX (US); Keith Samuel MARANTO, Frankfort, IL (US); Mark James SMRHA, Chicago, IL (US); Wade James WOMACK, Allen, TX (US); Nathan Eric BENTON, Dallas, TX (US)

(21) Appl. No.: 19/054,713

(22) Filed: Feb. 14, 2025

Related U.S. Application Data
(60) Provisional application No. 63/553,852, filed on Feb. 15, 2024.

(51) Int. Cl. G02B 6/38; G02B 6/44

(52) U.S. Cl. CPC G02B 6/3885; G02B 6/3825; G02B 6/3833; G02B 6/4403

(57) ABSTRACT

An apparatus comprises a module. The module includes a module housing and an array of Expanded Beam Optical (EBO) connectors extending from a front of the module housing. Each of the EBO connectors comprises a connector housing having a port at a front end of the connector housing, and a ferrule positioned within the port. a trunk cable extending from the rear of the housing. The trunk cable comprises a set of ribbon fibers that are broken out within the module housing and attached to the EBO connectors.

### CROSS-REFERENCE TO RELATED APPLICATIONS

This Application claims the benefit of U.S. Provisional Application Ser. No. 63/553,852, filed Feb. 15, 2024, which is hereby incorporated by reference for all purposes.

### BACKGROUND

Telecommunications, data centers, and high-performance computing environments rely on optical fiber connectivity to provide faster data transmission rates and higher bandwidths. Connections between optical fibers must support high fiber densities while maintaining low insertion losses. Traditional connectors, however, have often struggled with sensitivity to dust and contaminants, which can significantly degrade performance. Moreover, the physical forces required to insert and secure these connectors have presented challenges in environments where space is at a premium and ease of use is critical.

Expanded Beam Optical (EBO) connectors offer a more robust connection, mitigating the effects of dust and other contaminants. The EBO connector allows the light beam in the source connector to exit the fiber core and diverge within the connector for a short distance before the light is collimated to form a beam with a diameter greater than the core. In the receiving connector the beam is then focused back to its original diameter on the end of the receiving fiber.

Integrating the larger EBO connectors into systems that demand remarkably high fiber densities has proved challenging for traditional methods, while effective to a degree, often fall short in more demanding applications, particularly those in high thermal density datacenters where advanced cooling methods could introduce additional challenges regarding contaminants to optical connectivity.

### SUMMARY

In general, in one aspect, one or more examples relate to an apparatus that comprises a module. The module comprising a module housing and an array of Expanded Beam Optical (EBO) connectors extending from a front of the module housing. Each of the EBO connectors comprises a connector housing having a port at a front end of the connector housing, and a ferrule positioned within the port. a trunk cable extending from the rear of the housing. The trunk cable comprises a set of ribbon fibers that are broken out within the module housing and attached to the EBO connectors.

In another aspect, one or more examples relate to a method a method. The method includes providing a set of Expanded Beam Optical (EBO) connectors. Each of the EBO connectors comprises a connector housing that comprises a port at a front end of the connector housing; a closed face that extends laterally along the connector housing; an open face opposite the closed face; a channel extending from a rear of the housing to the port, wherein the channel is accessible from the open face; a ridge protruding from the closed face opposite the channel. Each of the EBO connectors further comprise a ferrule positioned within the port, and a ribbon fiber that is connected the ferrule and routed along the channel, to the trunk cable. The channel of a first EBO connector is coupled to a corresponding ridge of a second EBO connector to secure the ribbon fiber within the channel of the first EBO connector. An array of EBO connectors is formed from at least the first EBO connector and the second EBO connector.

Other aspects of the invention will be apparent from the following description and the appended claims.

### BRIEF DESCRIPTION OF DRAWINGS

FIG. 1 is a rack that is shown in accordance with one or more embodiments.

FIG. 2 is a panel that is shown according to illustrative embodiments.

FIGS. 3A and 3B illustrate a high-density module (212) with an integrated Expanded Beam Optical (EBO) connector system, shown according to illustrative embodiments.

FIGS. 4A and 4B illustrate a perspective cutaway view of the module, shown according to illustrative embodiments.

FIGS. 5A and 5B illustrate the structural configuration of an EBO connector, shown according to illustrative embodiments.

FIGS. 6A and 6B illustrate exploded views of an array of EBO connectors, shown according to illustrative embodiments.

FIGS. 7A and 7B illustrate the connection interface between an EBO connector and a mating connector, shown according to illustrative embodiments.

FIGS. 8A and 8B illustrate a set of mating connectors ganged together using a backshell, shown according to illustrative embodiments.

FIG. 9 is a flowchart for a method, shown according to illustrative embodiments.

Like elements in the various figures are denoted by like reference numerals for consistency.

### DETAILED DESCRIPTION

Embodiments of the invention are directed to a high-density fiber optic module that integrates Expanded Beam Optical (EBO) connectors into a structured array. The module includes a housing that retains multiple EBO connectors, each having a port, a ferrule, and a ribbon fiber routed through an internal channel. A trunk cable extends from the rear of the module, with ribbon fibers connecting to the EBO connectors. The connectors are secured using a ridge and channel engagement system, with clips arranged diagonally and anti-diagonally to maintain alignment. A backshell groups multiple mating connectors for simultaneous insertion into the EBO connectors. The module is designed to fit within a 1U panel, supporting different fiber densities based on the number of connectors and fibers per connector.

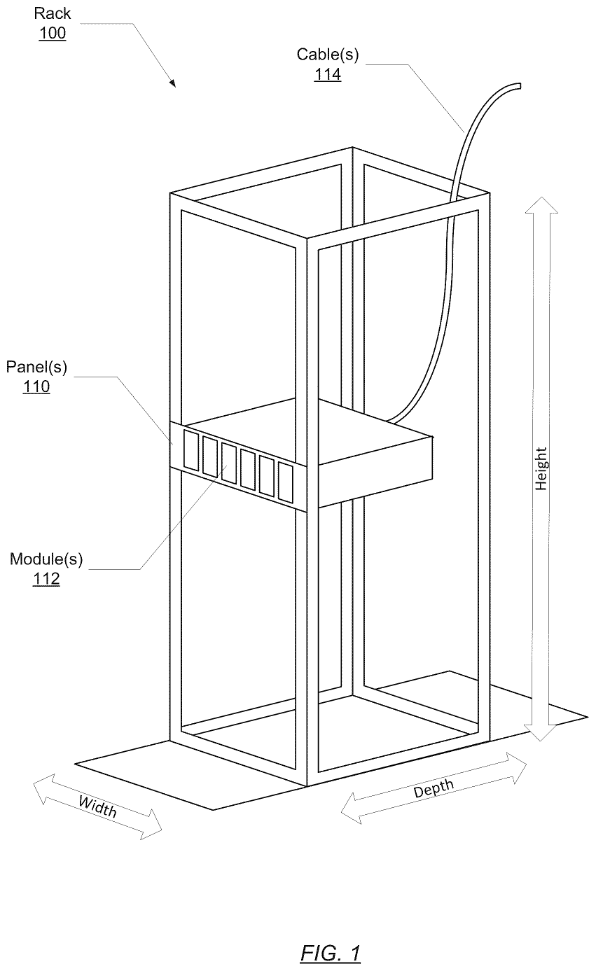

Turning to FIG. 1, a rack is shown in accordance with one or more embodiments. The rack (100) is a piece of telecommunications equipment that provides for the housing and organization of diverse telecommunication devices.

The outer dimensions of rack (100) conform with most network and server equipment. For example, rack width may measure 19 inches (48.26 cm) or 23 inches (58.42 cm) in width, standard measurements that are adhered to in the telecommunications industry. Other dimensions may be used, e.g., 21 inches, 23 inches, etc. The dimensions ensure that the rack can accommodate equipment with different form factors, such as 1U, 2U, or larger units, where “U” represents a standard rack unit of measure equal to 1.75 inches in height.

The rack (100) may include a series of uniformly spaced vertical mounting slots, located on both the front and rear, to facilitate the arrangement and mounting of various telecommunication devices and components. The slots serve as attachment points for mounting the panel(s) (110). The rack (100) may further be equipped with additional features such as ventilation openings and cable management.

Panel(s) (110) are components that mount within the rack (100) to organize, secure, and provide access to connective hardware. The panel may be constructed from materials such as steel or aluminum that can support the weight of the modules and withstand the physical demands of a data center environment.

Panel(s) (110) are formed with standardized form factors for compatibility with the mounting slots of the rack (100). For example, panel(s) (110) may include standardized mounting points to align with rack units, a layout that supports the intended cable or connector density, and provisions for labeling and user accessibility.

The panel(s) (110) may be equipped with one or more module(s) (112) to secure the fibers using ports, connector adapters, connectors, etc. Module(s) (112) are prefabricated units or sub-assemblies designed for quick installation into the rack (100). The module(s) (112) may include electronic components and/or optical components, such as optical connectors, optical fibers, switches, routers, or patches. The module(s) (112) may include features for splicing, cable management, and security.

The module(s) (112) are designed to contain a specific number of optical connectors, optimizing space utilization within the rack mount to support high fiber densities. For example, each module(s) (112) may support fiber densities of 144 fibers, 288 fibers, and/or 576 fibers per module, as well as other suitable densities. The connectors may be an industry-standard connector such as a standard connector (SC), Lucent connector (LC), or Multi-fiber Termination Push-on connector (MTP), depending on the network requirements. In some embodiments, the connectors may be an Expanded Beam Optical (EBO) connector.

The module(s) (112) may have multiple widths, such that a varying number of modules may be housed within the panel(s) (110). The module(s) (112) may be sized to fit twelve (12) modules in the panel(s) (110), however other sizes—e.g., 2, 3, 4, 6, 8—are also contemplated. When fully loaded with module(s) (112), the panel(s) (110) support fiber densities of 1728 fibers, 3456, fibers, and/or 6912 fibers per panel, as well as other suitable densities.

Cable(s) (114) may be fiber optic cables that carry data signals between different network devices and components. Cable(s) (114) are routed through the data center infrastructure, connecting panels, modules, and external devices. For example, cable(s) (114) may interconnect module(s) (112). Cable(s) (114) may include a core, cladding, and protective coating, which ensure the integrity of the data signal. Cable(s) (114) can be single-mode or multi-mode, depending on the network requirements. Cable(s) (114) may be color-coded to facilitate identification during installation and maintenance.

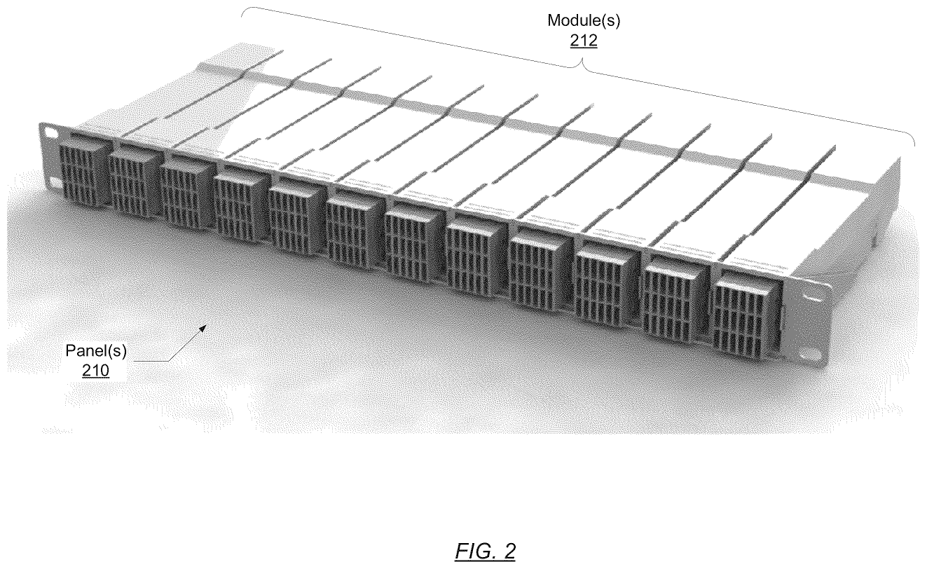

Referring now to FIG. 2, a panel is shown according to illustrative embodiments. The panel (210) is an example of panel (110) of FIG. 1. The panel (210) illustrates a high-density fiber optic panel incorporating multiple modular units (212). The panel (210) is a rack-mountable structure configured to accommodate a set of modules (212) in a linear arrangement along the front face of the panel. The modules (212) are positioned side by side, each housing a set of Expanded Beam Optical (EBO) connectors that extend outward from the front face of the module.

Each module (212) is configured to hold an array of EBO connectors that facilitate optical connections with external fiber optic cables. The EBO connectors are arranged in a row along the front face of each module (212), forming an array across the panel (210). The modules (212) are structured to fit within a defined panel height, allowing for a high-density arrangement of fiber optic connections.

The panel (210) is configured to be mounted within a standard rack system, enabling the integration of multiple panels within a datacenter or telecommunications environment.

Each EBO connector within the module (212) includes a connector housing that supports a ferrule positioned within a front-facing port. The module (212) houses a trunk cable that extends from the rear of the module, routing individual ribbon fibers to corresponding EBO connectors. The connectors are secured within the module housing, maintaining alignment and positioning for optical connections. The arrangement supports modular installation and removal, enabling reconfiguration and scalability within the fiber optic infrastructure. The structural alignment of the modules (212) and the panel (210) provides a means for organizing high fiber count interconnections within a compact space.

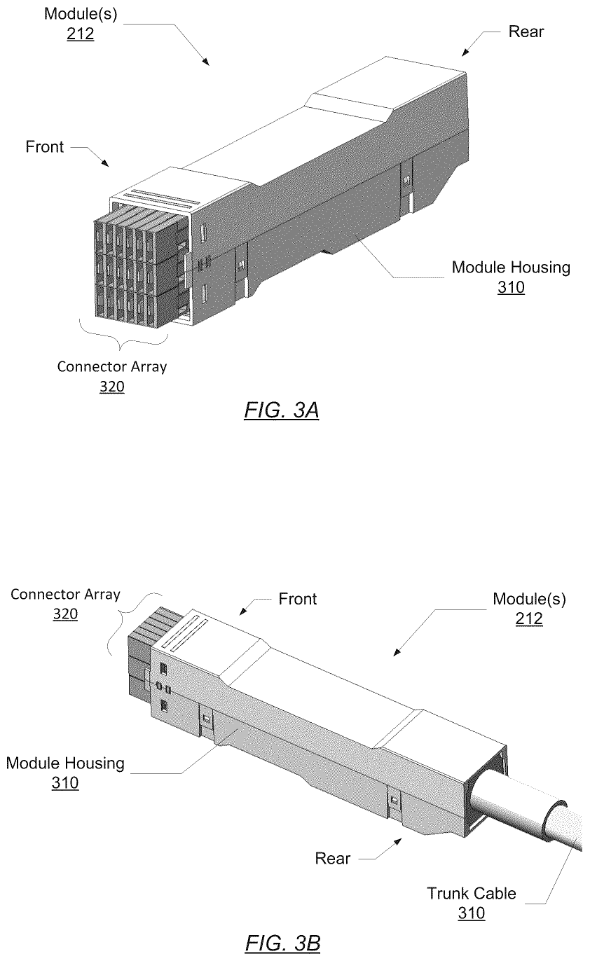

FIGS. 3A and 3B illustrate a high-density module (212) with an integrated Expanded Beam Optical (EBO) connector system. The module (212) comprises a module housing (310) that encloses and supports internal fiber routing and connector integration. The front of the module (212) features a connector array (320), which includes multiple EBO connectors arranged in a structured configuration for high-density fiber optic connections.

In FIG. 3A, the module housing (310) extends from the front to the rear of the module (212), providing an enclosure for fiber routing and connector alignment. The connector array (320) is positioned at the front of the module, allowing for external fiber connections through expanded beam optical interfaces. The structure of the module housing (310) is configured to retain the connectors in a fixed alignment while enabling modular insertion into a rack-mounted panel.

FIG. 3B shows the rear portion of the module (212), where a trunk cable (310) extends outward from the module housing (310). The trunk cable (310) comprises multiple ribbon fibers that are broken out within the module housing (310) and routed to individual connectors within the connector array (320). The positioning of the trunk cable (310) enables fiber management and organization within a structured cable routing system. The module housing (310) provides protection for internal components and maintains fiber alignment between the trunk cable (310) and the connector array (320).

The EBO connectors within the connector array (320) include a ferrule positioned within a front-facing port, facilitating expanded beam optical connections with external mating connectors. The arrangement of the connectors in the module (212) supports high fiber densities and allows for integration into a larger panel system. The design enables modular insertion and removal, supporting scalability and adaptability in high-density fiber optic environments.

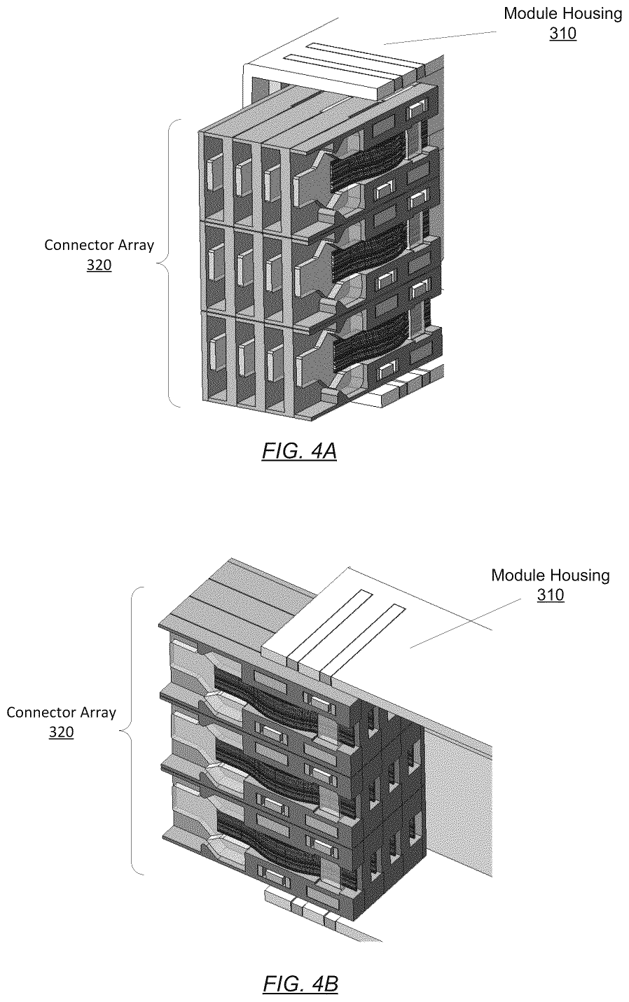

FIGS. 4A and 4B illustrate a perspective cutaway view of the module (212), revealing the arrangement and structural configuration of the connector array (320) within the module housing (310). The module housing (310) encloses multiple Expanded Beam Optical (EBO) connectors that are stacked in a structured array. The front face of the connector array (320) provides access to individual ports for optical connections.

The EBO connectors within the connector array (320) are positioned in a vertically stacked configuration. Each connector is secured within the module housing (310) and aligned with adjacent connectors to form a continuous array. The connectors include a front-facing ferrule positioned within a port, facilitating optical connections with external mating connectors. The alignment structure ensures uniform spacing and secure retention of the connectors within the module.

As shown, each EBO connector includes a housing that supports fiber routing and alignment. The connectors are arranged with a ridge-and-channel engagement mechanism that interlocks adjacent units. This structural configuration ensures fiber routing stability and maintains alignment between the connectors. The module housing (310) provides structural support and protection for the internal fiber routing.

The cutaway views reveal the internal arrangement of fiber routing within the module housing (310). Ribbon fibers extending from a trunk cable are routed within the housing and connected to individual EBO connectors. The positioning of the connectors within the module allows for efficient fiber management and high-density optical connections. The arrangement supports modular installation and removal within a rack-mounted fiber panel.

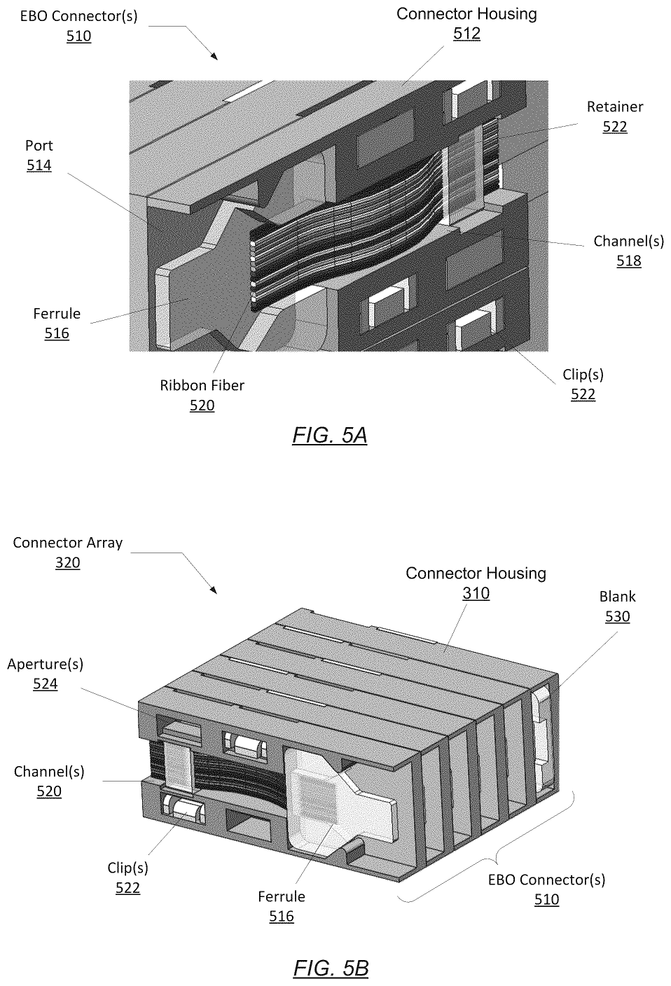

FIGS. 5A and 5B illustrate the structural configuration of an individual EBO connector (510) and a stacked arrangement of multiple EBO connectors within a module. FIG. 5A provides a detailed cutaway view of a single EBO connector (510), showing internal fiber routing and alignment features. FIG. 5B presents a perspective view of a stack of EBO connectors secured within the module housing (310).

Referring specifically to FIG. 5A, the EBO connector (510) includes a connector housing (512) that encloses and supports optical components. A port (514) is located at the front of the connector housing (512), providing an interface for optical coupling. Inside the port (514), a ferrule (516) is positioned to align optical signals for expanded beam transmission. The connector housing (512) further includes an internal channel (518) that extends from the rear of the housing to the port (514), guiding ribbon fiber (520) toward the ferrule (516). A retainer (522) is positioned along the channel (518) to secure the ribbon fiber (520) within the connector housing (512). Clips (522) are attached to the housing for alignment and securing the connector to adjacent units.

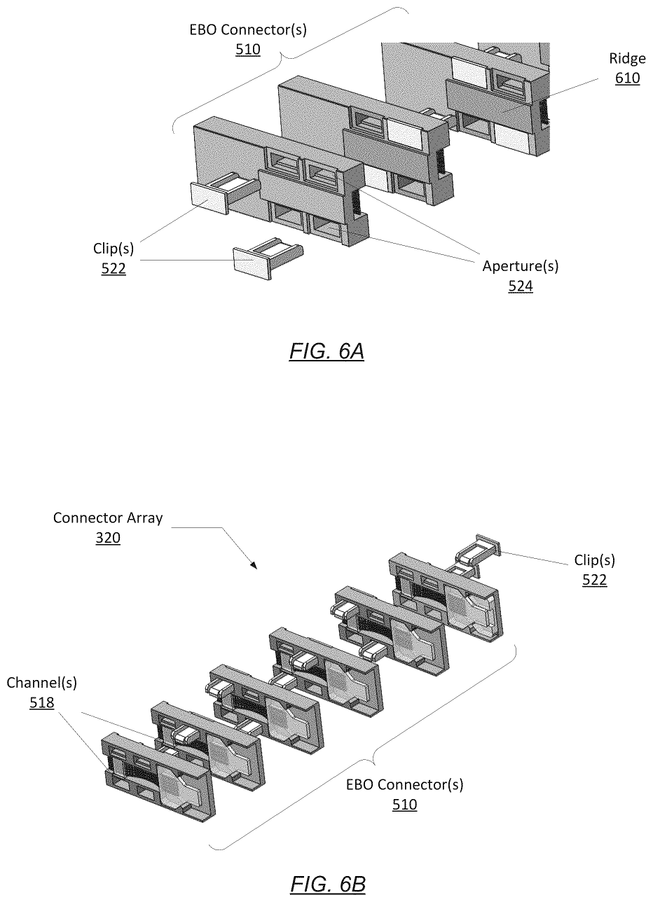

Referring now to FIG. 5B, a connector array (320) is shown consisting of multiple stacked EBO connectors (510) enclosed within the module housing (310). Each EBO connector (510) is aligned with adjacent connectors through a structured stacking mechanism, such as shown in FIG. 6. Channels (520) extend along the sides of the connector housing (512), providing pathways for routing ribbon fibers. Apertures (524) are present in the housing, allowing clips (522) to be inserted for securing adjacent connectors in the array. A blank (530) is positioned at the end of the stack, covering unused connector slots within the module housing (310). The structural configuration maintains fiber alignment while enabling modular assembly and scalability within the system.

FIGS. 6A and 6B illustrate exploded views of an array of Expanded Beam Optical (EBO) connectors (510), detailing their alignment features, securing mechanisms, and structured assembly within the module. FIG. 6A provides a perspective view of individual EBO connectors (510) separated from one another, highlighting their relative positioning and attachment components. FIG. 6B presents an expanded view of the connector array (320), showing the arrangement of connectors and the structured alignment facilitated by the securing elements.

In FIG. 6A, each EBO connector (510) includes a connector housing with a ridge (610) that extends along one side. The ridge (610) is designed to engage a corresponding channel in an adjacent connector, ensuring a structured alignment when assembled. Apertures (524) are positioned along the connector housing to receive clips (522), which secure adjacent connectors together. The clips (522) are inserted in a diagonal arrangement along the first EBO connector (510), engaging with the apertures (524) to secure the connection.

FIG. 6B illustrates the exploded view of the connector array (320), showing multiple EBO connectors (510) arranged in a structured formation. Each connector includes a channel (518) that extends along its length, providing a fiber routing path. The connectors interlock through the ridge (610) and channel (518) engagement while being secured by the clips (522). The clips (522) in the second EBO connector (510) are arranged in an anti-diagonal configuration, complementing the diagonal clip arrangement of the first connector. This alternating diagonal and anti-diagonal arrangement of clips (522) ensures stability within the assembled connector array, preventing movement while maintaining structural integrity. The stacked configuration facilitates high-density fiber management while ensuring alignment and secure retention within the module housing.

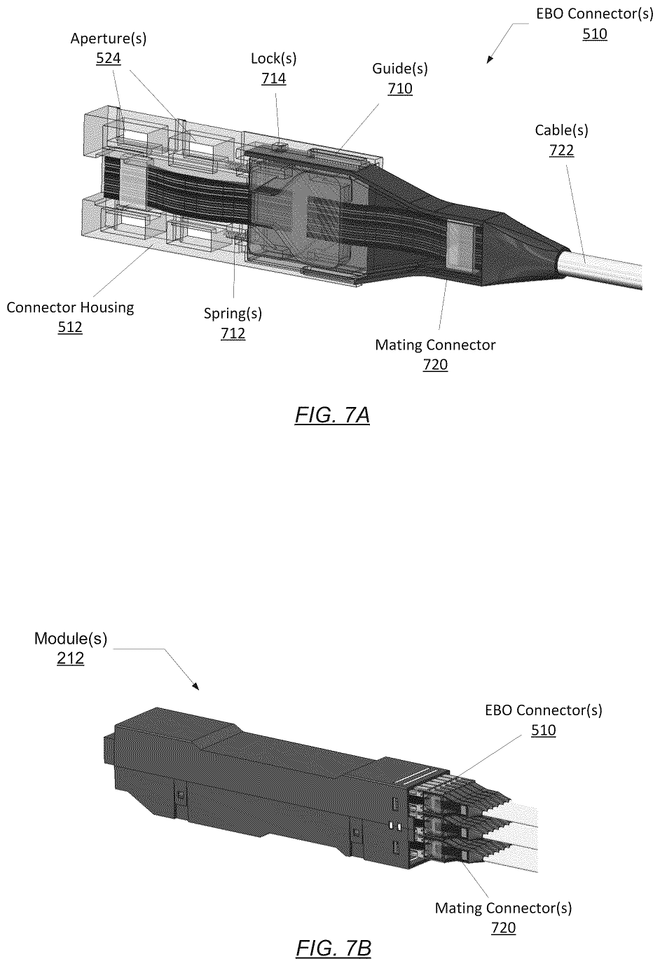

FIGS. 7A and 7B illustrate the connection interface between an Expanded Beam Optical (EBO) connector (510) and a mating connector (720), facilitating fiber optic transmission between a module (212) and an external cable (722). FIG. 7A provides a sectional perspective of an individual EBO connector (510) with an inserted mating connector (720), highlighting internal components that secure and align the optical connection. FIG. 7B presents a perspective view of a module (212) with multiple EBO connectors (510), each interfacing with corresponding mating connectors (720) attached to external cables (722).

In FIG. 7A, the EBO connector (510) comprises a connector housing (512) that encloses and supports internal optical components. The front of the connector housing (512) features guide(s) (710) that align the mating connector (720) during insertion. A set of spring(s) (712) is positioned within the housing to apply a controlled force, ensuring proper alignment of the ferrule and optical interface. The mating connector (720) is configured to engage with the EBO connector (510), securing an optical path for signal transmission through an expanded beam interface. The connector housing (512) includes aperture(s) (524), which facilitate mechanical engagement features such as locking mechanisms. Lock(s) (714) are integrated into the connector to secure the mating connector (720) once fully inserted.

FIG. 7B illustrates a module (212) incorporating multiple EBO connectors (510) at its front face, each connected to an external fiber optic cable (722) through a corresponding mating connector (720). The mating connectors (720) are aligned and inserted into the EBO connectors (510), forming a structured array that enables multiple optical connections within a compact space. The structured alignment of the connectors ensures consistent positioning and fiber routing within the module (212). The external cables (722) extend from the rear of the mating connectors (720), providing fiber optic connectivity between the module and an external fiber distribution system. The connection interface is designed to facilitate modular installation and removal, ensuring secure and stable optical coupling within high-density fiber optic environments.

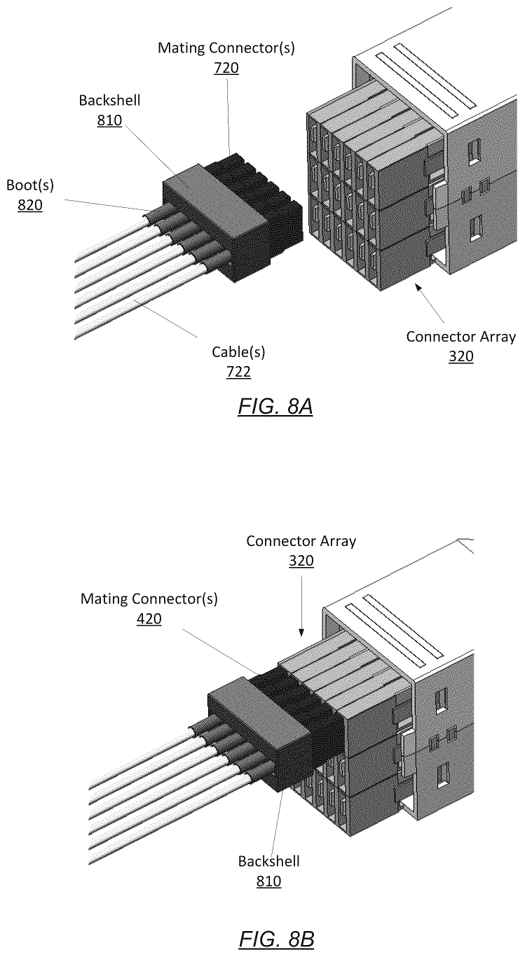

FIGS. 8A and 8B illustrate a set of mating connectors (720, 420) ganged together using a backshell (810) for simultaneous engagement with an array of Expanded Beam Optical (EBO) connectors (320). FIG. 8A provides a perspective view of the mating connectors (720) aligned with the connector array (320) prior to insertion, while FIG. 8B illustrates the mating connectors (420) fully engaged with the connector array (320).

In FIG. 8A, the connector array (320) is positioned at the front face of a module, comprising multiple EBO connectors arranged in a structured configuration. A set of mating connectors (720) is bundled together within a backshell (810), which provides structural support and alignment for simultaneous engagement with multiple EBO connectors in the array. The backshell (810) includes a boot (820) that is configured to support the cables (722), acting as a strain relief to prevent excessive bending or tension on the fiber optic cables. Each mating connector (720) is attached to a corresponding fiber optic cable (722), which extends from the rear of the backshell (810). The mating connectors (720) are aligned with the corresponding ports of the EBO connectors within the connector array (320), allowing for ganged insertion.

In FIG. 8B, the mating connectors (420) are fully inserted into the connector array (320), establishing optical connections between the external cables (722) and the module. The backshell (810) maintains the alignment of the mating connectors (420) during insertion and engagement, ensuring that each connector is properly seated within its respective port. The boot (820), as part of the backshell (810), provides strain relief for the cables (722) by distributing mechanical stress and maintaining proper cable routing. The structured arrangement of the mating connectors (420) within the backshell (810) allows for multiple optical connections to be established simultaneously with a single mating action. The configuration reduces installation time while ensuring secure optical coupling within the fiber optic system.

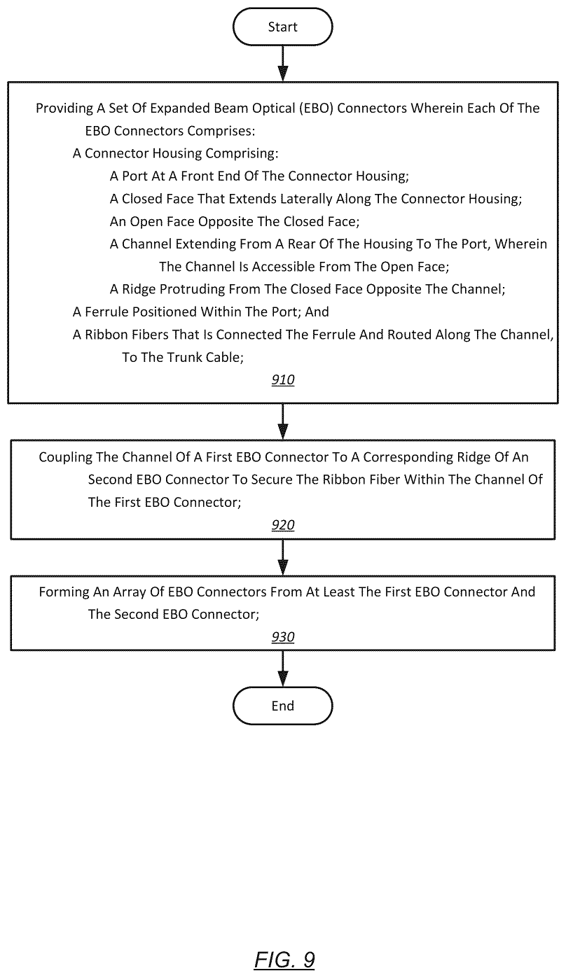

Turning now to FIG. 9 a flow chart for a method is shown in accordance with one or more embodiments. The flowchart of FIG. 9 shows a process of providing, coupling, and assembling an array of EBO connectors, such as the connector array (320) of FIG. 3.

Beginning at Step 910, a set of Expanded Beam Optical (EBO) connectors is provided, each including a connector housing that facilitates optical connections. The connector housing comprises a port at its front end, a ferrule positioned within the port for optical alignment, and a ribbon fiber routed along an internal channel. The channel extends from the rear of the housing to the port and is accessible from an open face opposite a closed face that extends laterally along the housing. A ridge protrudes from the closed face opposite the channel, enabling structural engagement with adjacent connectors. The ribbon fiber extends from the trunk cable, passes through the channel, and connects to the ferrule, establishing an optical path. This structure supports modular integration within a fiber management system.

At step 920, the channel of a first EBO connector is coupled to a corresponding ridge of a second EBO connector, securing the ribbon fiber within the channel of the first EBO connector. The engagement of the ridge and channel provides a structural interlock, ensuring that the connectors maintain alignment while supporting the routed ribbon fiber. The coupling process is facilitated by the presence of apertures along the housing, which accommodate securing elements. Clips are inserted along a diagonal into the apertures of the first EBO connector, locking it to the second EBO connector. A second set of clips is then inserted along an anti-diagonal into the apertures of the second EBO connector, securing it to a third EBO connector. This alternating diagonal and anti-diagonal clip arrangement ensures structural stability and prevents lateral displacement of the connectors.

At step 930, an array of EBO connectors is formed from at least the first and second EBO connectors. The connectors are arranged in a structured configuration, where additional EBO connectors are sequentially coupled using the ridge-channel engagement and secured with diagonally and anti-diagonally placed clips. The completed array is integrated into a module that accommodates 9, 12, 15, or 18 EBO connectors, depending on the desired fiber density. The module is designed to fit within a 1U panel, where 12 such modules form a high-density fiber distribution system. In one configuration, the array comprises twelve EBO couplers within a 1U height, totaling 192 couplers across the panel, supporting 1,728 fibers. In another embodiment, eighteen EBO couplers per module result in a total of 216 couplers per panel, supporting 3,456 fibers. In a further configuration, the same arrangement is scaled to support 6,912 fibers by increasing the fiber count per EBO connector to 32.

In some embodiments, the method enables multiple fiber connections to be established with a single mating action, improving efficiency in high-density fiber optic installations. A set of mating connectors are ganged into a backshell to form a set of ganged connectors. The backshell aligns and secures the mating connectors while providing strain relief for the cables extending from the connectors. The ganged connectors are configured for simultaneous insertion into the ports of at least a portion of the EBO connectors in the array, ensuring consistent engagement across multiple EBO connectors.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, “or” is an “inclusive or” and, as such includes “and.” Further, items joined by an or may include any combination of the items with any number of each item unless expressly stated otherwise.

The figures of the disclosure show diagrams of embodiments that are in accordance with the disclosure. The embodiments of the figures may be combined and may include or be included within the features and embodiments described in the other figures of the application. The features and elements of the figures are, individually and as a combination, improvements to the technology of keyword extraction using tags and n-grams. The various elements, systems, components, and steps shown in the figures may be omitted, repeated, combined, and/or altered as shown from the figures. Accordingly, the scope of the present disclosure should not be considered limited to the specific arrangements shown in the figures.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. An apparatus comprising a module, the module comprising:
a module housing;
an array of Expanded Beam Optical (EBO) connectors extending from a front of the module housing, wherein each of the EBO connectors comprises:
a connector housing having a port at a front end of the connector housing; and
a ferrule positioned within the port; and
a trunk cable extending from the rear of the housing, wherein the trunk cable comprises a set of ribbon fibers that are broken out within the module housing and attached to the EBO connectors.

2. The apparatus of claim 1, wherein:
each EBO connector supports a fiber density of 16 fibers or 32 fibers per connector;
the module is configured to hold the array of EBO connectors, wherein the array includes 9, 12, 15, or 18 EBO connectors; and
the module is sized to fit 12 modules within a 1U panel.

3. The apparatus of claim 2, wherein the array comprises twelve EPO couplers, within a 1U height, of 192 couplers of the panel comprising a set of twelve modules including the module, providing 1728 fibers using the 192 couplers.

4. The apparatus of claim 2, wherein the array comprises eighteen EPO couplers, within a 1U height, of 216 couplers of the panel comprising a set of twelve modules including the module, providing 3456 fibers using the 216 couplers.

5. The apparatus of claim 2, wherein the array comprises eighteen EPO couplers, within a 1U height, of 216 couplers of the panel comprising a set of twelve modules including the module, providing 6912 fibers using the 216 couplers.

6. The apparatus of claim 1, wherein the connector housing further comprises:
a closed face that extends laterally along the connector housing;
an open face opposite the closed face;
a channel extending from a rear of the housing to the port, wherein the channel is accessible from the open face; and
wherein a respective one of the set of ribbon fibers is routed along the channel, connecting the ferrule to the trunk cable.

7. The apparatus of claim 6, wherein the connector housing further comprises:
a ridge protruding from the closed face opposite the channel;
wherein the ridge is configured to couple to a corresponding channel of an adjacent EBO connector in the array, securing a respective one of the set of ribbon fibers within the corresponding channel of the adjacent EBO connector.

8. The apparatus of claim 6, wherein the connector housing further comprises a set of apertures, the apparatus further comprising:
a set of clips that are insertable into the set of apertures, wherein the clips are configured to secure the housing to an adjacent EBO connector in the array.

9. The apparatus of claim 8, wherein the array comprises a first EBO connector and a second EBO connector that is adjacent to the first EBO connector;
wherein a first set of clips that are inserted into apertures of the first EBO connector are arranged along a diagonal, and a second set of clips that are inserted into apertures of the second EBO connector are arranged along a counter-diagonal.

10. The apparatus of claim 1, wherein the connector housing further comprises:
a set of guides for receiving a mating connector that is inserted into the port;
a set of springs configured to bias the mating connector; and
a lock configured to secure the mating connector when the mating connector has been fully inserted into the port.

11. The apparatus of claim 1, further comprising:
a backshell configured to retain a set of mating connectors in a ganged arrangement corresponding to at least a portion of the EBO connectors in the array.

12. A method comprising:
providing a set of Expanded Beam Optical (EBO) connectors wherein each of the EBO connectors comprises:
a connector housing comprising:
a port at a front end of the connector housing;
a closed face that extends laterally along the connector housing;
an open face opposite the closed face;
a channel extending from a rear of the housing to the port, wherein the channel is accessible from the open face;
a ridge protruding from the closed face opposite the channel;
a ferrule positioned within the port; and
a ribbon fiber that is connected the ferrule and routed along the channel, to the trunk cable;
coupling the channel of a first EBO connector to a corresponding ridge of a second EBO connector to secure the ribbon fiber within the channel of the first EBO connector; and
forming an array of EBO connectors from at least the first EBO connector and the second EBO connector.

13. The method of claim 12, wherein each connector housing further comprises a set of apertures, the method further comprising:
inserting a first set of clips along a diagonal into a respective set of apertures of the first EBO connector; and
securing the first EBO connector to second EBO connector with the first set of clips.

14. The method of claim 13, further comprising:
inserting a second set of clips along an anti-diagonal into a respective set of apertures of the second EBO connector; and
securing the second EBO connector to a third EBO connector with the second set of clips.

15. The method of claim 12, further comprising:
ganging a set of mating connectors into a backshell to form a set of ganged connectors; and
inserting the set of ganged connectors into the ports of at least a portion of the EBO connectors in the array.

16. The method of claim 12, wherein:
each EBO connector supports a fiber density of 16 fibers or 32 fibers per connector;
the module is configured to hold the array of EBO connectors, wherein the array includes 9, 12, 15, or 18 EBO connectors; and
the module is sized to fit 12 modules within a 1U panel.

17. The method of claim 16, wherein the array comprises twelve EPO couplers, within a 1U height, of 192 couplers of the panel comprising a set of twelve modules including the module, providing 1728 fibers using the 192 couplers.

18. The method of claim 16, wherein the array comprises eighteen EPO couplers, within a 1U height, of 216 couplers of the panel comprising a set of twelve modules including the module, providing 3456 fibers using the 216 couplers.

19. The method of claim 16, wherein the array comprises eighteen EPO couplers, within a 1U height, of 216 couplers of the panel comprising a set of twelve modules including the module, providing 6912 fibers using the 216 couplers.

20. A module comprising:
a module housing;
an array of Expanded Beam Optical (EBO) connectors extending from a front of the module housing, wherein each of the EBO connectors comprises:
a connector housing having a port at a front end of the connector housing;
comprises:
a closed face that extends laterally along the connector housing;
an open face opposite the closed face; and
a channel extending from a rear of the housing to the port, wherein the channel is accessible from the open face;
a ridge protruding from the closed face opposite the channel; and
a set of apertures;
a ferrule positioned within the port;
a set of clips that are insertable into the set of apertures; and
a trunk cable extending from the rear of the housing:
wherein the trunk cable comprises a set of ribbon fibers that are broken out within the module housing and attached to the EBO connectors;
wherein a respective one of the set of ribbon fibers is routed along the channel, connecting the ferrule to the trunk cable;
wherein the ridge is configured to couple to a corresponding channel of an adjacent EBO connector in the array, securing a respective one of the set of ribbon fibers within the corresponding channel of the adjacent EBO connector;
wherein the clips are configured to secure the housing to an adjacent EBO connector in the array.
